(19) United States
(12) Patent Application Publication
(10) Pub. No.: US 2003/0158785 A1
(43) Pub. Date: Aug. 21, 2003

(54) System and method for distributing information to anonymous requestors

(76) Inventor: Christopher J. Erca, Westport, CT (US)

Correspondence Address: Raymond J. Werner, 2092 NW Aloclek #525, Hillboro, OR, 97124, US

(21) Appl. No.: 10/081,070

(22) Filed: Feb. 21, 2002

(51) Int. Cl. G06F 17/60

(52) U.S. Cl. 705/26

(57) ABSTRACT

Methods and apparatus for fulfilling a request for information, goods, or services, while maintaining at least partial anonymity of the requester include receiving from a requestor an indication of the request and at least one identifying code. A request packet is generated which includes the identifying code of the requestor along with information identifying the entity to which the request was submitted. The request packet may optionally contain information indicating which one of a plurality of locations operated by the entity has received this particular request, and may further optionally contain information indicating which one or ones of a plurality of fulfillment packages is to be distributed. A service provider receives the request packet, and determines, from a locally maintained database and based on the requestor's identifying code, at least where to distribute the fulfillment package.

### BACKGROUND OF THE INVENTION

1. Field of the Invention

The present invention relates generally to distribution of information and services, and more particularly to systems methods for delivering, in response to an anonymous request, information and/or services desired by an anonymous requester.

2. Background

Advances in semiconductor manufacturing technology, integrated electronics, and digital systems architectures, have lead to the deployment, in modern times, of a vast array of electronic products, including those necessary for powerful computer systems, sophisticated communications infrastructure elements, and various consumer electronics devices capable of accessing the flexible and high-speed communications networks made possible by these computers and communications infrastructure elements.

A number of products and services have been developed to provide users, or customers, with the ability to electronically order goods, services, and information. For example, Internet access devices such as computers, personal digital assistants, and even cellular phones permit access to web sites from which goods and services may be requested or purchased. Unfortunately, many such electronic access methodologies result in the aggregation of personal information by web site operators and others. The aggregation of personal information raises concerns in connection with how well the privacy and confidentiality of such information is maintained. It is believed that such information, once collected, has often been spread through the Internet and otherwise, such that consumers receive unsolicited communications, and in some cases have suffered outright identity theft which has adversely affected credit ratings and caused all manner of legal problems for those consumers.

What is needed are systems and methods for distributing information, products and services to a consumer who makes a request for same, while maintaining some degree of anonymity for that consumer of such information, products, or services.

### SUMMARY OF THE INVENTION

Briefly, methods and apparatus for fulfilling a request for information, goods, or services, while maintaining at least partial anonymity of the requester provide for receiving, from a requester, an indication of the request and at least one identifying code. The indication of the request and the at least one identifying code may be one and the same. A request packet is generated which includes the identifying code of the requester along with information identifying the entity to which the request was submitted. The request packet may optionally contain information indicating which one of a plurality of locations operated by the entity has received this particular request, and may further optionally contain information indicating which one or ones of a plurality of fulfillment packages is to be distributed. A service provider receives the request packet, and determines, based at least in part on the requestor's identifying code and the contents of a user profile maintained by the service provider, at least where to distribute a fulfillment package.

In one aspect of the present invention, a user profile provides information which controls the performance of a request fulfillment organization in terms of the location and manner of delivering a fulfillment package; and further in terms of the degree of personal information which may be disseminated by the request fulfillment organization.

### BRIEF DESCRIPTION OF THE DRAWINGS

The features, objects, and advantages of the present invention will become more apparent from the detailed description set forth below when taken in conjunction with the drawings in which like reference characters identify the same or similar elements throughout.

FIG. 1 is a block diagram representation of a system in accordance with the present invention.

FIG. 2 is a schematic representation of a request packet data structure.

FIG. 3 is a block diagram representation of a corporate service subscriber subsystem that includes a variable display.

FIG. 4 is a flowchart of an illustrative process in accordance with the present invention that shows the operation of a request aggregator.

FIG. 5 is a flowchart of an illustrative process in accordance with the present invention that shows the operation of a request fulfillment organization.

FIG. 6 is a flowchart of an illustrative process, in accordance with the present invention, that shows the interaction between a request aggregator and a request fulfillment organization.

### DETAILED DESCRIPTION

Various illustrative embodiment of the present invention are discussed in detail below. While specific steps, configurations, and arrangements are discussed, it should be understood that this is done for illustrative purposes only. A person skilled in the relevant art will recognize that other steps, configurations, and arrangements can be used without departing from the spirit and scope of the present invention.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Terminology

Individual service subscriber refers to an individual or an entity which provides a user profile to a request fulfillment organization, and receives, typically from the request fulfillment organization, hardware and/or software necessary to submit requests to a request aggregator. The expression individual service subscriber is a reflection of the fact of a subscription to services provided by a request fulfillment organization. It is noted that for the purposes of this disclosure, the subscription relationship between the individual service subscriber and the request fulfillment organization may be one that involves the payment of one or more subscription, or other types of fees, or the subscription relationship may not require the payment of fees on the part of the individual service subscriber. An individual service subscriber may also be referred to herein as a consumer.

Submitting a request refers to communication between an individual service subscriber and a request aggregator which initiates a transaction. The information communicated to the request aggregator includes at least the individual service subscriber's identification code. Various means for submitting a request include, but are not limited to, magnetic stripe cards encoded with the identification code, RFID tags encoded with the identification code, and low-power transmitters (e.g., Bluetooth, or IEEE 802.11) embedded in consumer electronic devices such as a cell phone, a personal digital assistant (PDA), pager, or the like. With respect to magnetic stripe cards, RFID tags, and similar items, these are brought into direct or proximate contact with a reader; whereas with respect to consumer electronic devices with low-power transmitters mentioned above, request submission may be achieved simply by pushing a button, or any similar interactions, which initiates the request function.

Request aggregator refers to an entity, typically, but not necessarily, a commercial organization, that possesses the equipment for receiving a request from an individual service subscriber, generating a request packet, and communicating that request packet to the request fulfillment organization. The request aggregator may collect, or buffer, a two or more requests (i.e., aggregate the requests) prior to communicating request packets to a request fulfillment organization. A request aggregator may also be referred to herein as a corporate service subscriber.

Request fulfillment organization refers to a service provider that receives request packets from request aggregators, and based, at least in part, on the request packets and the user profiles, fulfills the request by delivering information, goods, or services in accordance with the user profile instructions. A request fulfillment organization may also be referred to herein simply as the service provider.

Fulfillment package refers to that information, product, service, or any combination thereof, that is delivered and/or provided to a requester in a manner initiated by a request fulfillment organization in accordance with an individual subscriber's user profile. Typically, the request aggregator provides the information or product to the request fulfillment organization, and may update the contents or nature thereof as desired. For electronic content, the request aggregator may have electronic access to the request fulfillment organization to make such timely updates to that content.

Overview

Generally, embodiments of the present invention provide individuals with the means to request information and/or goods, and/or services, where the information, goods or services are associated with a particular organization, and the request is fulfilled while the requestor remains either totally or partially anonymous to the organization. The ability to provide partial or fully anonymous request fulfillment, in accordance with the present invention, results from decoupling the request submission interaction with the consumer, from the request fulfillment operation. In this way, a consumer may provide an identification code to an organization from which that consumer desires to receive information, goods, or services, wherein no personal information is discernable from the identification code. The submission of a request, in accordance with the present invention, involves an individual service subscriber communicating an identification code by way of an RFID tag, a low-power RF transmission from a cell phone, personal digital assistant (PDA), a physical swipe of a magnetic stripe card, or any other suitable means of providing an individual service subscriber's identification code to a request aggregator. In various embodiments, an RFID tag may be embedded in or on items including, but not limited to, a cell phone, a PDA, a pager, a key fob, and similar items that are readily transportable by an individual service subscriber. The request aggregator passes on the consumer's identification code along with information specifying how the consumer's request is to be satisfied, to a request fulfillment organization.

The request fulfillment organization, in accordance with the present invention, maintains a database, or any other suitable information storage and retrieval system, from which it can match the consumer's identification code with the consumer's actual instructions for fulfilling a request. Examples include, but are not limited to, an email address to which to send information; a street address to which printed matter or other goods are to be sent; billing information indicating how to make payment for various goods or services; and so on. The information that is associated with a consumer's identification code, and which is in the possession of the request fulfillment organization, is referred to herein as a user profile.

Within the scope of the present invention the user profile may be simple or complex. In an example of a simple user profile, the user profile may contain only an address to which information or goods are to be delivered. In an example of a more complex user profile, the user profile may contain multiple addresses along with delivery instructions that direct various categories of information, goods, and services to various ones of the multiple addresses. In this way, for example, a request for vacation travel information can result in a fulfillment package (i.e., the vacation travel information) being sent to a home address, while a request for office equipment information can result in a fulfillment package (i.e., the office equipment information) being sent to an office address. Similarly, the user profile can direct that information be sent electronically, physically, or by both methods.

A clear advantage of embodiments of the present invention is that a request, such as, for example, a request for information, can be handled completely electronically. By reducing or eliminating physical delivery of hardcopy information, valuable resources, such as those used for the manufacture and delivery of hardcopies (e.g., trees and fossil fuels) can be conserved.

The user profile can also be used to direct, when the fulfillment of a particular request requires a payment, how to pay for the request fulfillment package. That is, electronic funds transfers can be automatically initiated when the request fulfillment package (i.e., the requested information, goods, or services) is either shipped, delivered, or accepted, as specified in the user profile. Similarly, the user profile may specify a particular account or accounts from which funds are to be transferred, or to which charges are to be billed.

In some embodiments of the present invention, the request aggregator collects voluntarily submitted biometric data from the individual service subscriber along with the identification code, in order to guard against unauthorized financial transactions in the event of an item containing an individual identification code is stolen. It is well known in the fields of authentication and secured transactions, that a greater level of security for a transaction may be had by requiring from the requestor both an item assigned to the requestor (e.g. the identification code assigned to an individual service subscriber); and a biometric reading which identifies a unique characteristic of the requestor. As used in this description of biometric authentication, unique may mean a characteristic that completely and unambiguously identifies the requester, or a characteristic the identifies the requester to within some predetermined degree of probability (e.g., the odds of a false positive identification are one in ten million).

The user profile may also specify whether complete, partial, or no anonymity is to be maintained in connection with a particular request, or with particular categories of requests. For example, the data in the user profile may indicate that some or all of the personal information associated with the individual subscriber may be provided to a particular request aggregator, or to one or more request aggregators that represent a defined class. By defined class it is meant that a request aggregator be of a certain type, such as for example, an office services provider, a medical information provider, a restaurant equipment provider, an architectural services provider, and so on. In this way, the individual service subscriber specifies how his or her personal information may be distributed. Typically, the personal information of the individual service subscriber that submits a request to a request aggregator is not provided to that request aggregator unless the user profile of the individual subscriber specifies that such information may be released.

It is noted that user profiles are typically stored within a database under the control of the request fulfillment organization. In an alternative embodiment of the present invention, one or more request aggregators may maintain databases of user profiles wherein those user profiles are created by the collection of information submitted to the request aggregators by individuals. However, such an arrangement does not provide the same degree of decoupling as is possible with the arrangement in which the user profiles are maintained separately from the request aggregators.

In a manner similar to that described above, the user profile of an individual service subscriber may also specify whether the request fulfillment organization may aggregate personal information regarding the individual service subscriber's use of the service, and if aggregated how that data may be used by the request fulfillment organization.

It is noted that even though the corporate service subscriber obtains, processes and communicates the individual service subscriber identification code, the corporate service subscriber does not possess the information needed to associate an individual service subscriber identification code with a particular individual or entity.

Illustrative System

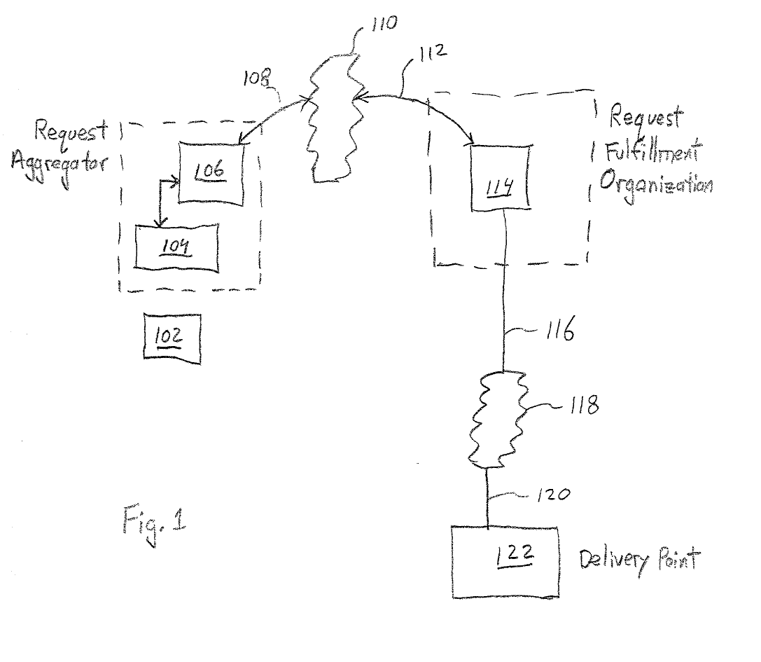

Referring to FIG. 1, an illustrative system 100 is shown which includes a tag 102 which is operable to wirelessly communicate with a reader 104. Tag 102, which is described in greater detail below, is typically carried by a person, commonly referred to herein as an Individual Service Subscriber. Reader 104 is coupled to a computer 106 which is provides the computational and communication resources for assembling one or more packets of information to be transmitted to a remote service provider, commonly referred to herein as a request fulfillment organization. In a typical arrangement, reader 104 and computer 106 are operated by an entity commonly referred to herein as a Corporate Service Subscriber.

Computer 106 is coupled by way of communications link 108 to communications network 110. Communications link 108 may be any suitable means of coupling computer 106 to communications network 110, but is commonly implemented as a modem within computer 106 hooked to a plain old telephone service (POTS) connection. Alternatively, connections such as, but not limited to, Integrated Services Digital Network (ISDN), Digital Subscriber Loop (DSL), leased lines such as T1, T2, or T3, broadband cable, wireless links to satellite-based communications services providers, or any other suitable network infrastructure may be used, along with the appropriate modem or other communications interface.

In this illustrative embodiment computer 106 may be any suitable device such as, but not limited to any of a wide variety of personal computers which are commonly available. Such personal computers typically include input/output (I/O) interfaces by which reader 104 may communicate to computer 106 information which it received in its interaction with tag 102. Software running on, that is executed by, computer 106 processes the information from reader 104 and creates one or more packets of information, referred to herein as request packets, and passes those request packets to communication software for transmission over communication network 110. Such communication software stacks for personal computers are well-known and widely available, and so are not described in greater detail herein.

The request packets include data that identifies the individual service subscriber, and the corporate service subscriber. In alternative embodiments where more than one item is associated with the corporate service subscriber for distribution, further data is included in the request packet which provides the necessary instructions for the service provider to distribute the correct item or items to the individual service subscriber. Put another way, when a single request aggregator has multiple items that may be requested, there needs to be a mechanism by which the request aggregator can communicate which one or ones of these items the request fulfillment organization must distribute to satisfy the request. In this alternative embodiment one or more additional codes are included in the request packet in order to let the request fulfillment organization know what items are to be distributed. In this way, the individual service subscriber receives the requested information, or product, or service, from the service provider rather than from the corporate service subscriber, and therefore the individual service subscriber maintains anonymity in the transaction with the corporate service subscriber.

In one illustrative example of a single request aggregator having multiple items which may be selected, a large retail store (the request aggregator in this example) has several readers (devices through which a consumer submits a request) and those readers are located in particular areas of the store that are related to particular products or categories of products. In this example, when a consumer submits a request, the location of the reader within the store is recognized, and a request packet is generated that includes not only the information which identifies the request aggregator to a request fulfillment organization, but also includes information specific to identifying the products or categories of products for which, for example, information is to be sent to the consumer. Typically the specific reader is identified by way of an ID code associated with that reader, and communicated to the computer, or similar computation device, which generates the request packet. Such an ID code may be stored within the reader, or may be a network node address such as an address associated with an Ethernet or any other type of network, by which the reader communicates with the computer.

Still referring to FIG. 1, communications network 110 of the illustrative embodiment is also coupled, by way of a communications link 112, to a computer system 114. Communications link 112 may be similar, or identical to communications link 108, described above. Computer system 114 is typically implemented as a database server, and is operated by an entity commonly referred to herein as the Service Provider. The service provider may also be referred to as a request fulfillment organization, an information provider, an information distributor, and by similar terms and expressions indicative of the functions of the service provider in terms of distribution of information, and/or goods, and/or services. In this illustrative embodiment, database server 114 operated by the service provider receives one or more request packets from computer 106 of the corporate service subscriber. The request packets, as indicated above, include data that identifies the corporate service subscriber and the individual service subscriber.

FIG. 1 also shows a communications link 116 which couples database server 114 to a communications network 118, which in turn is coupled by way of communications link 120 to a delivery point 122. Delivery point 122 is a target for information distribution. Delivery point 122 can be an email address, a phone number, or any other suitable target for electronic receipt of information. Delivery point 122 may be electronic means within the home of an individual service subscriber, or may be electronic means located anywhere else as determined by the individual service subscriber. In alternative embodiments where the requested item or items are not susceptible of electronic delivery, the request fulfillment organization arranges for distribution, or delivery of the requested items in accordance with the user profile. In this way, for example, when an item must be delivered physically rather than electronically, a user profile may direct that the item be delivered by mail, delivered by overnight package delivery service, held for pick-up, or any other suitable direction.

Communication links 116, 120, and communications network 118, may be similar, or identical, to those described above in connection with communication links 108, 112, and communications network 110.

In one illustrative embodiment tag 102 is carried by an individual. Tag 102 may be embedded, or incorporated in, or integrally formed with, any suitable item that is easily carried, such as, but not limited to, a card, key fob, pocket knife, glove, or other personal item. Tag 102 may be thought of as the front-end of a Radio Frequency Identification (RFID) system. Tag 102 typically contains a coiled wire that acts a both a receiving and transmitting antenna. In one embodiment tag 102 includes integrated circuits which provide memory and radio circuit functionality. The memory is used to store a preprogrammed individual identification code which is subsequently transmitted to a counterpart receiver (i.e., reader 104) which is remote from tag 102. In one embodiment the transmitting frequency of tag 102 is 125 KHz. The information encoded, i.e., programmed onto the integrated circuits of tag 102 may be programmed in any suitable format now known to, or later developed by, those skilled in the art.

It is noted that in alternative embodiments of the present invention, the function of the tag may be provided by other types of devices, including but not limited to, magnetic stripe cards that can be swiped through a magnetic stripe card reader, bar coded items that can be presented to a bar code reader, cellular phones or other consumer electronic devices capable of low-power wireless communication, and infrared communication devices embedded with the information needed to transmit the individual service subscriber's identification code.

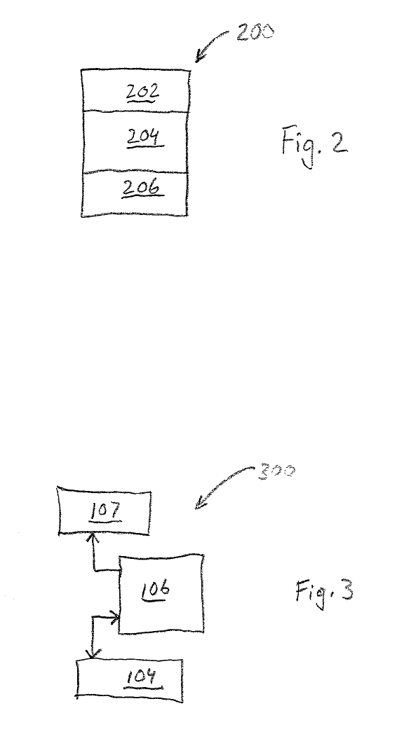

Referring to FIG. 2, a logical data structure representing an illustrative request packet 200 is shown. Request packet 200 includes a corporate service subscriber identification field 202, an individual service subscriber identification field 204 and a requested item identifier field 206. The corporate service subscriber identification field 202 provides information to the service provider regarding the identity of the corporate service subscriber. As will be readily understood by those skilled in the computer software arts, this information may be in the form of one or more codes that represent the identity of the corporate service subscriber, or may be in the form of the actual name of the corporate service subscriber. In various alternative embodiments of the present invention, corporate service subscriber identification field 202 may also include information that identifies which one of a plurality of locations occupied by the corporate service subscriber has originated the request packet. Individual service subscriber identification field 204 typically contains the data necessary to identify the individual service subscriber to the service provider (but not to the corporate service subscriber). This information, in combination with the user profile, is typically used by the service provider to determine where and how to deliver the information, goods, or services specified by, or otherwise determined from, request packet 200. Requested item identifier field 206, may be useful in various embodiments of the present invention, but is not required by all embodiments. Requested item identifier field 206 provides a facility by which the corporate service subscriber communicates to the service provider, which one or ones, of a plurality of information, goods, or services to distribute to the individual or entity defined by individual service subscriber identification field 204.

It is noted that the particular order of the fields in the request packet and the data contained therein may be rearranged within the scope of the present invention.

FIG. 3 is a block diagram representation of a corporate service subscriber subsystem 300 that includes a variable display 107. More particularly, corporate service subscriber subsystem 300 may be implemented as a kiosk that displays various items that may be requested by anonymous requesters (i.e., individual service subscribers). In a typical embodiment, variable display 107 is implemented as a display, such as signage coupled with a reader, a liquid crystal display (LCD), or cathode ray tube (CRT) display, which is coupled to computer 106. Computer 106 drives display 107 under software control such that various items are shown which may be requested by an individual service subscriber. If the individual service subscriber submits a request during a time window that corresponds with the display of a requestable item, then a request packet is subsequently generated with the individual service subscriber's identification code and a requested item identifier that corresponds with the item displayed during the aforementioned time window. By having a time window which begins after the display of a requestable item, and which ends prior to a change of the displayed requestable item, a guardband is established so that a requestor does not accidentally request an item displayed prior to, or subsequent to the display of the desired item.

It is noted that the term “item” as used above may refer to information, and/or goods, and/or services.

### ILLUSTRATIVE PROCESS EXAMPLES

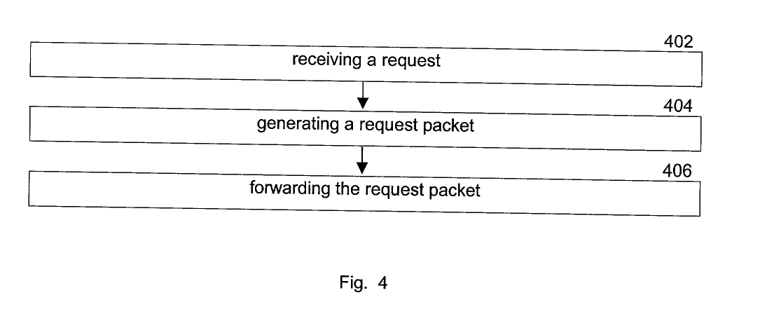

Referring to FIG. 4, an illustrative process in accordance with the present invention which provides for operations of a request aggregator includes receiving 402 a request at the request aggregator, the request including an individual identifier; generating 404 a request packet, wherein generating the request packet comprises forming a data packet that includes data based, at least in part, on the individual identifier, and further including data identifying the request aggregator; and forwarding 406 the request packet.

As indicated above, the request aggregator may receive a request from an individual service subscriber in any suitable manner, including but not limited to, bringing an RFID tag into proximity with the request aggregator's tag reader. The tag reader may be in the window of the request aggregator business location, or it may be placed within a room such that a window or other separator is not disposed between the tag and the reader. Similarly, the request may be received from an individual service subscriber using a magnetic stripe card, a non-volatile memory stick, a low-power RF transmitter, an IR transmitter, or any other suitable means of communicating the individual service subscriber's identification code to the request aggregator. Of course, the request aggregator must provide the appropriate “reader” to accept the identification code. The various exemplary communication means described above all have commercially available counterparts (e.g., magnetic stripe card readers, or RF receivers), and these are not described in greater detail herein.

The request packet is generated by a computer, or any other suitable device possessing the appropriate computational resources. The request packet, typically in digital format, may have its fields, and bit patterns arranged in any suitable or convenient manner. The computer, or other suitable device, may then forward, or communicate the request packet to a request fulfillment organization. Such communication may be wired, wireless, or a combination thereof; and may be circuit-switched, packet-switched, or a combination thereof. Data communication methods between computers are well-known and are not described in greater detail herein.

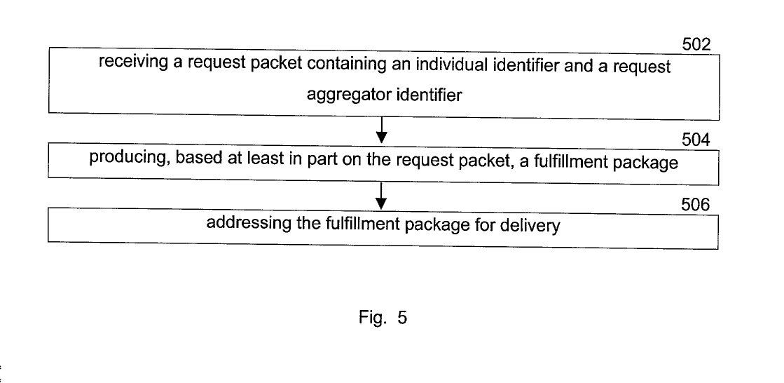

Referring to FIG. 5, an illustrative process in accordance with the present invention which provides anonymous request fulfillment, includes receiving 502 a request packet containing an individual identifier and a request aggregator identifier; producing 504, based at least in part on the request packet, a fulfillment package; and addressing 506 the fulfillment package for delivery. The request packet is received by the request fulfillment organization which uses the data in the request packet to determine what it is that is to be provided to an individual service subscriber. This determination may be made in the simplest case by looking at the request aggregator identification code. In this simplest case, the request aggregator has only one item to be delivered and so knowing the identity of the request aggregator by default defines the item to be delivered. In a more sophisticated case, where the request aggregator has a plurality of items that may be requested, the request fulfillment organization looks to a requested item identifier in the request packet. The requested item identifier determines which one of several fulfillment packages is to be delivered. The request aggregator addresses the fulfillment package for delivery in one or more of several ways. For example, if the fulfillment package comprises information to be delivered electronically, then addressing may be done by creating an email with the information and properly addressing the email. In another example, the fulfillment package may need to be physically delivered, and the request fulfillment organization then prepares, typically by printing, a mailing label, or shipping label. The addresses are determined by reading the user profile associated with the individual service subscriber's identification code contained within the request packet. A fulfillment package may have multiple components some of which are delivered to different electronic and/or physical addresses, all as may be specified in the user profile.

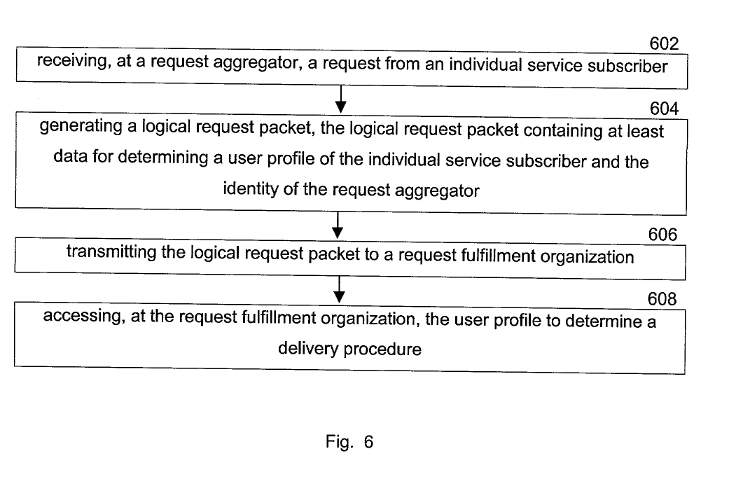

Referring to FIG. 6, an illustrative process in accordance with the present invention which provides for fulfilling a request with at least partial anonymity for a requester, includes receiving 602, at a request aggregator, a request from an individual service subscriber; generating 604 a logical request packet, the logical request packet containing at least data for determining a user profile of the individual service subscriber and the identity of the request aggregator; transmitting 606 the logical request packet to a request fulfillment organization; and accessing 608, at the request fulfillment organization, the user profile to determine a delivery procedure. The illustrative process of FIG. 6, demonstrates the interaction between the request aggregator and the request fulfillment organization with respect to the formation and communication of the request packet. It will be appreciated that in some embodiments of the present invention, the request fulfillment organization may communicate, in accordance with rules set forth in a user profile, information regarding the individual service subscriber that made a particular request. For example, an individual service subscriber may provide in his or her user profile, that age data, or income data, may be provided to the request aggregator but not address data, or name data. Any such logical combination of rules for disseminating an individual service subscriber's personal information may be set forth in the user profile. These rule sets are typically interpreted by software running on one or more computers, or similar computational devices, operated for the benefit of the request fulfillment organization. By “operated for the benefit of”, it is meant that the request fulfillment organization may operate such computers, or computational devices, or some other organization may actually possess and operate the computers with the computational results provided to the request fulfillment organization.

Request aggregators, or corporate service subscribers, may encompass a wide variety of organizations including, but not limited to, individual stores, restaurants, hotels, travel services, automobile dealers, movie theaters, banks, local government offices, and the like. In one embodiment of the present invention, the request aggregators are charged one or more fees to the request fulfillment organization. These fees may be fixed periodic (e.g., monthly) fees, or may be a combination of fixed fees and fees based on factors such as, but not limited to, the number and complexity of transactions performed by the request fulfillment organization on behalf of the request aggregator.

Individual service subscribers, in some embodiments of the present invention, are charged one or more fees by the request fulfillment organization in exchange for the services rendered. Services rendered include, but are not limited to, maintaining a user profile for the individual service subscriber, and delivering one or more fulfillment packages.

In various embodiments of the present invention multiple identification codes can be assigned to a single consumer. In this example, a tag having a first identification code may be incorporated with a cell phone that might send the information only to the cell phone, or to the cell phone and the consumer's home email address (as specified in the user's profile associated with the first identification code).

In an alternative embodiment, hotels provide tag-equipped PDAs, or similar devices, to their guests. In such a scenario the hotel acquires a block of identification codes from the request fulfillment organization. The guests may then walk around town swiping kiosks (i.e., submitting requests) with attractions, restaurants, and similar request aggregators. Information provided in by the request fulfillment organization in response to such requests may be communicated to, and be perceived from the PDA, or similar device. Alternatively, the user profile set up by the hotel may direct the request fulfillment organization to deliver requested information (e.g., directions, restaurant reviews, etc.) to be sent to a computer, or similar device accessible in the room of the guest.

In another alternative embodiment of the present invention, individual service subscribers may receive one or more statements describing or showing the requests that they have made. In various embodiments, the individual service subscribers may specifically request a statement, or they may request periodic statements, or statements may be sent by the request fulfillment organization without being requested by the individual service subscribers. Individual service subscribers may specify how statements describing or showing their requests are to be delivered, by providing such instructions in their user profiles. In some embodiments, the request fulfillment organization may charge a fee for providing such statements. In other embodiments, individual service subscribers may access a record of their requests by accessing, via a web browser, a web page maintained by the request fulfillment organization.

Conclusion

Thus, it can be seen from the above disclosure and drawings, that methods and apparatus for fulfilling a request for information, goods, or services, with partial or complete anonymity have been described. This is made possible, at least in part, by decoupling, that is, separating, the act of requesting an item from the act of delivering the item. In this way, an entity receives a request including an identification code which cannot be associated with the requestor's personal information by the entity receiving the request.

Some advantages of various embodiments of the present invention include the anonymity for the requestor of information, goods, or services; and economies of scale for the request fulfillment organization.

Another advantage of some embodiments of the present invention includes the ability to request fulfillment organization to aggregate useful marketing information.

Various aspects of the present invention may be implemented as circuit-based solutions, including possible implementation on a single integrated circuit. As would be apparent to one skilled in the art, various functions of circuit elements may also be implemented as processing operations in a software program. Such software may be employed in, for example, a digital signal processor, micro-controller, or general-purpose computer.

The present invention can be embodied in the form of methods as well as apparatuses for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the claims.

What is claimed is:

1. A method, comprising:
receiving a request at a request aggregator, the request including an individual identifier;
generating a request packet, wherein generating the request packet comprises forming a data packet that includes data based at least in part on the individual identifier, and further including data identifying the request aggregator; and
forwarding the request packet.

2. The method of claim 1, wherein generating the request packet further comprises forming the data packet to include at least one fulfillment code.

3. The method of claim 1, wherein forwarding the request packet comprises addressing the packet to a request fulfillment organization.

4. The method of claim 1, wherein forwarding the request packet comprises transmitting the request packet to a request fulfillment organization.

5. The method of claim 1, wherein receiving the request comprises supplying a RF field adequate to activate an RFID tag and receiving a transmission from the activated RFID tag.

6. The method of claim 1, wherein receiving the request comprises receiving an RF signal.

7. The method of claim 6, wherein the RF signal is received from a low-power transmitter.

8. The method of claim 1, further comprising displaying information regarding one or more items available for request.

9. The method of claim 8, wherein displaying information regarding one or more items comprises providing a series of displays sequentially, and further comprising providing a timing window within which the request can be received, the timing window representing a time period less than the time period for which information is displayed.

10. A method of providing anonymous request fulfillment, comprising:
receiving a request packet containing an individual identifier and a request aggregator identifier;
producing, based at least in part on the request packet, a fulfillment package; and
addressing the fulfillment package for delivery.

11. The method of claim 10, further comprising determining a profile of an individual service subscriber based, at least in part, on the individual identifier.

12. The method of claim 11, wherein determining the profile comprises accessing a database.

13. The method of claim 12, further comprising delivering the fulfillment package.

14. The method of claim 13, wherein the fulfillment package is an electronic data packet.

15. The method of claim 13, wherein the fulfillment package includes printed materials.

16. The method of claim 10, wherein the request packet includes packaged goods.

17. The method of claim 12, further comprising determining the content of the fulfillment package based on the request aggregator identifier and a requested item identifier.

18. The method of claim 11, wherein the profile of the individual service subscriber comprises at least one delivery address.

19. The method of claim 11, wherein the profile of the individual service subscriber comprises at least one delivery address for email deliveries, at least one delivery address for service delivery, and at least one delivery address for delivery of goods.

20. The method of claim 19, wherein the profile of the individual service subscriber further comprises instructions regarding the dissemination of the individual service subscriber's personal information to at least one request aggregator.

21. A method of fulfilling a request with at least partial anonymity for a requester, comprising:
receiving, at a request aggregator, a request from an individual service subscriber;
generating a logical request packet, the logical request packet containing at least data for determining a user profile of the individual service subscriber and the identity of the request aggregator;
transmitting the logical request packet to a request fulfillment organization; and
accessing, at the request fulfillment organization, the user profile to determine a delivery procedure.

22. The method of claim 21, wherein the logical request packet comprises at least two data packets that, taken together, represent the contents of the logical request packet.

23. The method of claim 21, wherein the delivery procedure includes instructions for where to deliver a requested item.

24. The method of claim 23, wherein the requested item comprises information.

25. The method of claim 21, wherein the user profile specifies rules for handling the individual service subscriber's personal information.
